(19) United States
(12) Patent Application Publication
(10) Pub. No.: US 2006/0194079 A1
(43) Pub. Date: Aug. 31, 2006

(54) Method of producing sheetrock, and sheetrock produced by the same

(76) Inventor: Eugene Ettlinger, Riverdale, NY (US)

Correspondence Address: ILYA ZBOROVSKY, 6 Schoolhouse Way, Dix Hills, NY, 11746, US

(21) Appl. No.: 11/066,942

(22) Filed: Feb. 26, 2005

(51) Int. Cl. B32B 13/00

(52) U.S. Cl. 428/703

(57) ABSTRACT

A sheetrock has at least one sheetrock article having two opposite surfaces, wherein at least one of the surfaces is treated with an aqueous solution of copper-8-quinolinolate.

### BACKGROUND OF THE INVENTION

The present invention relates to a method of producing sheetrock, and sheetrock produced by the same.

It is known to produce sheetrock from corresponding constructional materials, so that it can be used in new construction and in old construction for repairs. Sheetrock is one of the most popular materials in the current construction and is used actually everywhere for residential and commercial construction. The existing sheetrock however is not provided with any features which can impart to it bactericidal and fungicidal properties.

### SUMMARY OF THE INVENTION

Accordingly, it is an object of the present invention to provide a sheetrock and method of producing the same, which is a further improvement of the existing methods and sheetrocks.

In keeping with these objects and with others which will become apparent hereinafter, one feature of the present invention resides, briefly stated, in a method of producing a sheetrock, comprising the steps of producing a sheetrock article; and treating at least one surface of the sheetrock article with an aqueous solution of copper-8-quinolinolate so as to provide bactericidal and fungicidal properties in the at least one surface of the sheetrock article.

It is another feature of the present invention to provide a sheetrock article which is composed of a sheetrock and has at least one surface treated with an aqueous solution of copper-8-quinolinolate with at least one additive, for providing bactericidal and fungicidal properties to the at least one surface.

When the method is performed and the sheetrock is formed in accordance with the present invention, at least one surface of the sheetrock has bactericidal and fungicidal properties, and therefore when the sheetrock in accordance with the present invention is used in new construction and in old construction, automatically bactericidal and fungicidal protection is provided for, a space in which the sheetrock in accordance with the present invention is utilized.

The novel features which are considered as characteristic for the present invention are set forth in particular in the appended claims. The invention itself, however, both as to its construction and its method of operation, together with additional objects and advantages thereof, will be best understood from the following description of specific embodiments.

### DESCRIPTION OF THE PREFERRED EMBODIMENTS

In accordance with the present invention a method of producing sheetrock is proposed, and a sheetrock produced by the method is proposed to be used for construction purposes.

In accordance with the inventive method a conventional sheetrock is first made, as well known in the art, and therefore does not require additional explanations. The conventional sheetrock in form of an article, for example a sheet of certain dimensions has two opposite surfaces formed so tat one of the surfaces serves as an exterior surface to face toward a frame or the like and attached to the same, while the other surface is an interior surface to face toward an inner space of residential and commercial structures.

In accordance with the present invention at least one of the surfaces is treated with an aqueous solution of copper-8-quinolinolate (copper oxine) For treatment of the at least one surface the copper-8-quinolinolate (C₈H₆NO)₂Cu is dissolved in water in a concentration between 1:30,000 to 1:200,000. It is also possible to treat both surfaces of the sheetrock article with the aqueous solution of copper-8-quinolinolate, to further increase bactericidal and fungicidal properties of the sheetrock.

In accordance with the present invention, at least one additive is added to the aqueous solution of copper oxide. In one embodiment of the present invention a urea solution is added in the quantity of 2.5-3.5 weight percent. It provides thixotropic flow behavior of the substance and also acts as an anti-setting agent.

In accordance with another embodiment of the present invention ammonium polyphosphate is added to the aqueous solution of copper-8-quinolinolate. It acts as a fire retardant to slow down the spread of fire. Ammonium polysulfate can be added in quantity of 4-5 weight percent of the aqueous solution of copper-8-quinolinolate.

In accordance with still a further feature of the present invention, magnesium aluminum silicate is added to the aqueous solution of copper-8-quinolinolate in the quantity of 0.2-0.4 percent. It acts as an anti-caking agent.

It is to be understood that one of the above mentioned additives, or a combination of two of the above mentioned additives, or all three above mentioned additives can be added to the aqueous solution of copper-8-quinolinolate.

In order to apply the aqueous solution of copper-8-quinolinolate, possibly with additives, on at least one surface (preferably both surfaces) of the sheetrock article it is possible to use spraying with a corresponding spray equipment, or brushing with a corresponding paint brush. It is also possible to immerse the sheetrock articles into a bath of the aqueous solution of copper-quinolinolate, so as to provide application of the same on one or both surfaces of the sheetrock articles.

Approximately one gallon of the substance in accordance with the present invention can cover substantially 175-250 square feet of the sheetrock products.

It will be understood that each of the elements described above, or two or more together, may also find a useful application in other types of methods and materials differing from the types described above.

While the invention has been illustrated and described as embodied in a method of producing sheetrock, and sheetrock produced by the same, it is not intended to be limited to the details shown, since various modifications and structural changes may be made without departing in anyway from the spirit of the present invention.

1. A method of producing sheetrock, comprising the steps of producing a sheetrock article having two opposite surfaces; and applying on at least one of the surfaces an aqueous solution of copper-8-quinolinolate with an anti-caking agent.

2. A method as defined in claim 1, wherein said applying includes applying the aqueous solution of copper-8-quinolinolate with a concentration of copper-8-quinolinolate 0.1-1.5 weight %.

3. A method as defined in claim 1; and further comprising adding at least one additive to the aqueous solution of copper-8-quinolinolate.

4. A method as defined in claim 3, wherein said at least one additive is a thixotropic and anti-settling agent.

5. A method as defined in claim 3, wherein said at least one additive is a fire retardant agent.

6. A method as defined in claim 3, wherein said at least one additive includes a thixotropic and anti-settling agent and also a fire-retardant agent.

7. A method as defined in claim 1, wherein said treating includes brush coating of the at least one surface on the sheet article.

8. A method as defined in claim 1, wherein said treating includes spray coating of the at least one surface of the article.

9. A method as defined in claim 1, wherein said treating includes immersing the sheetrock article into a bath with the aqueous solution of copper-8-quinolinolate.

10. A sheetrock, comprising at least one sheetrock article having two opposite surfaces, wherein at least one of the surfaces is treated with an aqueous solution of copper-8-quinolinolate with an anticaking agent.

11. A sheetrock as defined in claim 9, wherein said at least one surface is treated with the aqueous solution of copper-8-quinolinolate which has a concentration of copper-8-quinolinolate 0.1-1.50 weight %.

12. A sheetrock as defined in claim 10, wherein said at least one surface is treated with the aqueous solution of copper-8-quinolinolate with the anti-caking agent and with at least one additive.

13. A sheetrock as defined in claim 12, wherein said at least one additive is a thixotropic and anti-settling agent.

14. A sheetrock as defined in claim 12, wherein said at least one additive is a fire retardant agent.

15. A sheetrock as defined in claim 12, wherein said at least one additive includes a thixotropic and anti-settling agent and also a fire-retardant agent.

16. A sheetrock as defined in claim 10, wherein said treating includes brush coating of the at least one surface on the sheet article.

17. A sheetrock as defined in claim 10, wherein said treating includes spray coating of the at least one surface of the article.

18. A sheetrock as defined in claim 10, wherein said treating includes immersing the sheetrock article into a bath with the aqueous solution of copper-8-quinolinolate.
